(19) United States
(12) Patent Application Publication
(10) Pub. No.: US 2024/0262686 A1
(43) Pub. Date: Aug. 8, 2024

(54) Two Bags on Valve Shelf-Stable Hypochlorous Acid System

(71) Applicant: Emmett Manuel Cunningham, Glen Allen, VA (US)

(72) Inventor: Emmett Manuel Cunningham, Glen Allen, VA (US)

(21) Appl. No.: 18/428,739

(22) Filed: Jan. 31, 2024

Related U.S. Application Data
(60) Provisional application No. 63/576,318, filed on Feb. 3, 2023.

(51) Int. Cl. C01B 11/04; B01J 19/00

(52) U.S. Cl. CPC C01B 11/04; B01J 19/0066

(57) ABSTRACT

The present invention is related to the treatment or prevention of infection and, more particularly, to the treatment or prevention of viral or bacterial infection diseases by chlorination using liquid or fluid gel hypochlorous acid (HOCl) in the form of a nasal spray or nasal irrigation solution or as a liquid or fluid gel spray or dressing for wounds, ulcers acne, vaginal, gum diseases, tattoo or tattoo removal or burns.

### CROSS-REFERENCE TO RELATED APPLICATIONS

This application claims priority to co-pending U.S. Provisional Patent Application Ser. No. 63/576,318, filed 3 Feb. 2023, which is incorporated herein as though fully set forth.

### TECHNICAL FIELD

Hypochlorous acid is the result of a chemical reaction between an alkaline base chlorine, an acid, and water. In a chemical reaction, chemical equilibrium is the state in which both reactants are present in particular concentrations that have no further tendency to change over time. Usually, this state results when the forward reaction proceeds at the same rate as the reverse reaction. The reaction rates of the forward and backward reactions are generally not zero, but equal. Thus, there are no net changes in the concentrations of the reactant(s) and the product(s). This state is commonly referred to as the dynamic equilibrium.

And this is achieved in this invention by separation of the two base reactants, chlorine in an alkaline state and a pH controlling liquid in an acidic state (with or without sodium chloride and/or an inorganic, anti-settling, surfactant), stored in individual secure plastic (air and watertight) bags inside a single vessel, a spray can. This ensures the stability of the end product, HOCl, once it's mixed, enters an unstable state equilibrium. However, HOCl is stable enough for immediate use when the two base chemicals are kept separate, like in this invention, and mixed at the nozzle for instant spray contact or fogging use. This invention, also, allows for the two bag on bag spray can to be applied from any direction.

This invention ensures that the HOCl, or Hypochlorous acid plus Salt (HOCl+NaCl), contacts the surfaces, atmosphere or wound, burn, acne, ulcer, tattoo, or nasal passages at its full intended use or strength. This is desirable when treating a cold or virus, through the nasal passages. It is also desirable to retain its pH of 5-6.5 to match the pH of the nasal passage, so as not to disrupt the pH balance of the Nasal concha or Turbinate, internal naris and Nasopharynx and allows for a physiologically stable treatment. According to embodiments of the invention, the pH of a resulting product can vary from 1 to 9, at which point the HOCl is no longer present. Products of the invention are effective within a pH range of 3 to 7 and preferably in a range of 5 to 6.5.

As used herein, the terms “shelf-stable” or “shelf stability” refer to the ability of a solution to maintain at least about 80% of its original disinfecting power for a particular period of time. A solution deemed “shelf-stable” for two years, for example, would retain at least about 80% of its original disinfecting power for two years after production of a two bag vessel separation container, assuming storage at normal room temperature.

This invention answers both the need for a shelf stable, dependable chorine based disinfectant HOCl and the end of a requirement for “on location” electrolyzing machines and supplies, which comes with the dangers of handling the chemicals.

### BACKGROUND

Since its inception in the early 1970s, a solution derived from the electrolization of a mild sodium chloride and water mixture into a strong disinfectant (often called “Anolyte” or “electrolyzed water, EOW, ECA”), industry has longed for an effective Hypochlorous acid disinfectant that would maintain shelf stability for more than a few weeks or months. With such a short shelf/effective life, the need to produce Hypochlorous acid on site became the only viable solution. This created an industry in itself, producing and selling expensive machines that had to be maintained on location, e.g., in hospitals, schools, nursing homes, military facilities, etc. But this is cost prohibitive for small institutions, businesses, and homes. This invention makes one of the worlds' most effective disinfectants available to the public for a greatly reduced cost.

Household bleach (NaClO) has long been available and used to create disinfection solutions, but the shelf stability of bleach is a function of its extremely high pH, which preserves the chlorine, albeit in a form not available for effective disinfection. Once diluted, even chlorine-based products have a short shelf life.

The goal of sanitarians is to maximize disinfection performance while minimizing the labor time required and damage to personnel, equipment, and products. Shelf-stable Hypochlorous acid (HOCl) would achieve all these goals. Because of its varying strength, it can be sprayed on the surfaces of any item and not require subsequent removal. Based on the chemical nature of the product and its purity in this invention, it can be left to dry and retain some of its disinfection properties for hours or days if not wiped off. The science behind this is simple, the basic chemical properties of the remains become active when wet, and all microbes, bacteria, viruses, molds, etc., are wet.

The present invention is related to the treatment or prevention of infection and, more particularly, to the treatment or prevention of viral or bacterial infection diseases by chlorination using liquid or fluid gel hypochlorous acid (HOCl) in the form of a nasal spray or nasal irrigation solution or as a liquid or fluid gel spray or dressing for wounds, ulcers acne, vaginal, gum diseases, tattoo or tattoo removal or burns.

The invention is further related to the prevention and treatment of acne, acne vulgaris, which can be controlled through the use of HOCl to kill the bacteria found in the acne sites. Bacteria can trigger inflammation and infection resulting in more severe acne. Propionibacterium acnes is a major cause of the unpleasant, sometimes disfiguring disease doctors call acne vulgaris. The bacteria live inside the pits in the skin that contain hair follicles and sweat glands and can be treated by applying a liquid or fluid gel form of HOCl.

Other human uses include the treatment or preventive care of Vaginal odors (Bacterial vaginosis) and the treatment or preventive care of bacteria causing gum disease (periodontal disease).

The invention also relates to the disinfection of surfaces and the atmosphere in a given space. More particularly, the disinfection of Hospital surfaces, including patient rooms, surgery room surfaces, and nurse stations. Embodiments of the invention are also intended for the general cleaning and disinfection of any common area surfaces, like in a home, office, warehouse, etc., and all volumes of air in a given enclosed space.

Uses of the various embodiments of the invention include mold remediation. Black mildew-mold is very common and easily eliminated by spraying a disinfection grade of liquid or fluid gelled hypochlorous acid onto the surfaces. Mildew-mold mycotoxins are also very dangerous and can be controlled by spraying a disinfection grade of liquid hypochlorous acid into the room's atmosphere, for example, by a disinfection spray “bomb” a spray “bomb” uses a single action lock-down spray button actuator on a spray can to deplete the spray can of all of its contents into the atmosphere and on all surfaces).

One very important use of the invention includes the treatment of rooms or spaces contaminated by a biological bacteria like Bacillus anthracis (Anthrax). Fogging Bombs could be placed around the room or space, by Hazmat Engineers, to fog the room's atmosphere and cover its surfaces with HOCl.

### SUMMARY

In one embodiment, the invention provides a method of producing hypochlorous acid (HOCl), the method comprising: mixing a first liquid comprising an alkaline chlorine-containing liquid and a second liquid comprising an acidic liquid to form a third liquid containing HOCl.

In another embodiment, the invention provides an apparatus for producing hypochlorous acid (HOCl), the apparatus comprising: a first container containing a first liquid comprising an alkaline chlorine-containing liquid; a second container containing a second liquid comprising an acidic liquid; and an actuator fluidly connected to the first and second containers, operable to mix the first and second liquids and dispense a third liquid comprising the mixed first and second liquids.

### BRIEF DESCRIPTION OF THE DRAWINGS

FIG. 1 shows a schematic of a system according to an embodiment of the invention;

FIG. 2 shows a partial cut-away schematic of a system according to an embodiment of the invention;

FIG. 3 shows various actuators suitable for use according to various embodiments of the invention; and

FIG. 4 shows a schematic of the production of hypochlorous acid.

### DETAILED DESCRIPTION

The invention provides methods and systems for treating or preventing viral/bacterial infection (e.g., colds, flu, wounds, ulcers, burns, tattoo or tattoo removal, and acne) and the disinfection of a given space and its atmosphere, including the Anthrax bacterium, mold remediation, and the elimination of odors caused by bacteria.

This includes the elimination of the common bacterial condition in a dog's or any pet's ears, which can lead to infections in the ear and causes odor. A rinse according to the invention cleans and disinfects the ears without stinging. It breaks down and removes wax and also kills bacteria causing infection. It's non-toxic, antibiotic-free and can be used as often as needed to maintain healthy ears, while safely killing up to 99.999% of common animal bacteria and germs that get into pets' ears.

When embodied as an eye care wash, the invention provides an antibiotic-free, all-natural, topical eye care rinse for use in all animal eyes. It is non-toxic and sting-free. It relieves eye irritation, burning, and scratching, while safely killing up to 99.999% of common animal bacteria and germs that get into pets' eyes.

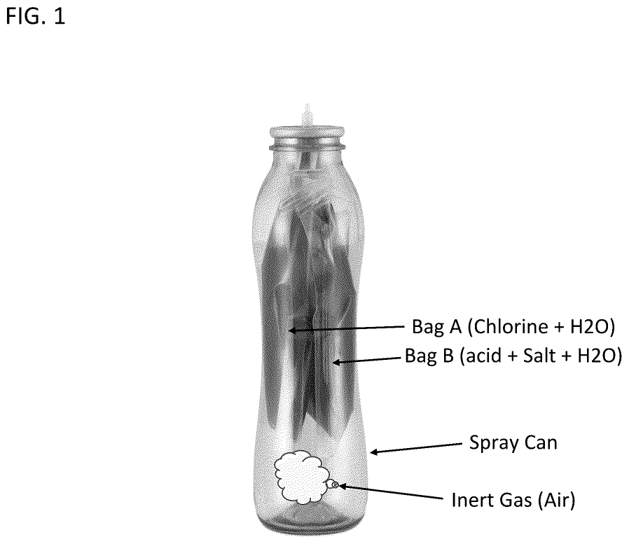

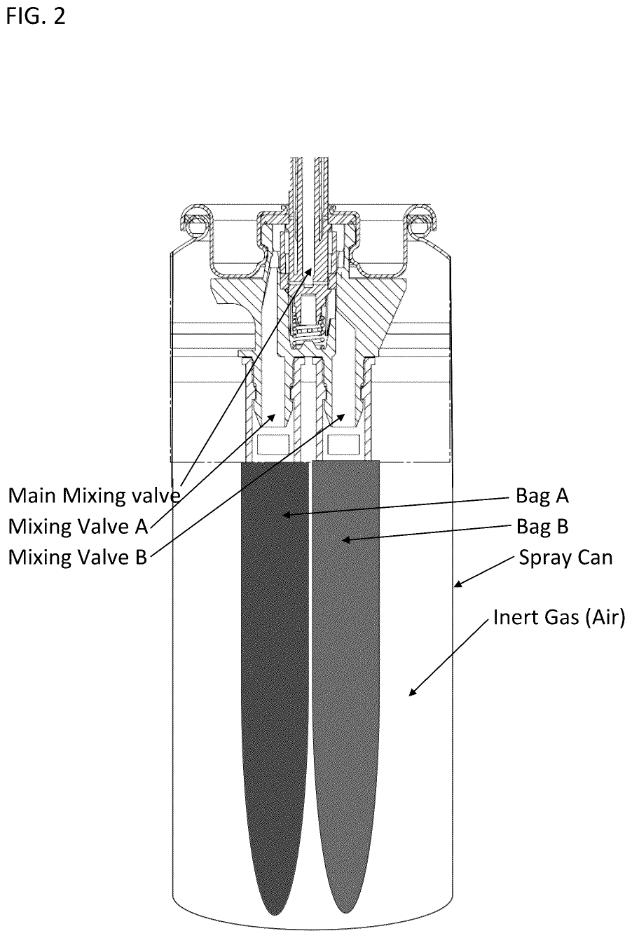

In one embodiment, the invention provides a method for the separation of the two Liquid elements within their own barrier packaging technology for liquid or viscous products in a three-to-four-layer laminate bag, of plastic and aluminum, offering a superior barrier which eliminates any possibility of oxidation and making it ideal for an oxidative product like Hypochlorous acid (HOCl) and combined into a single container, like a spray can using non-flammable propellants. Such an embodiment causes no explosive or inhalation of gas issues. Such an embodiment is shown in FIGS. 1 and 2.

In another embodiment, the invention provides a method to pressurize said spray can with a gas such as normal air or nitrogen. Since the two liquids are not associated with the propellant/s, there is no need to use a hydrocarbon propellant (Hydrocarbons-Propane, Isobutane, Normal butane plus, HFCs like HFC 134, HFC 152) and have to deal with its disposal into the atmosphere or if punctured or its final demise, the dump. This makes this invention both Earth Friendly and Sustainable.

In another embodiment, the invention provides a method in which said liquids are only mixed at the end of the Valve cap of the Actuator nozzle and are mixed at the end of said Valve cap through a mechanical mix/breakup in the Valve head. This means they are NOT mixed until needed in the final stage of the disbursement spray valve and always full strength at application. See, e.g., FIG. 2.

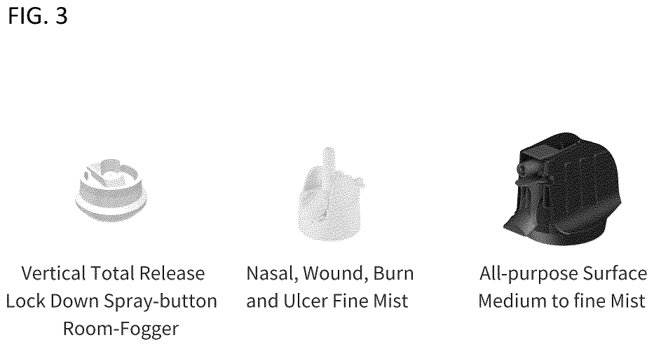

In another embodiment, the invention provides a method in which said liquids are only mixed at the end of the Valve cap of the Actuator nozzle with said Actuator being selected from a group of Actuators relevant to their purpose, e.g., a fine spray for nasal, wound, burn, acne, vaginal, gum disease, or ulcers, a medium mist for spraying surfaces and a fog spray for whole room spray-bombs (for surfaces and atmosphere). Illustrative actuators are shown in FIG. 3.

In another embodiment, the invention provides a method of treating or preventing infection (such as a cold, flu or viruses) in an individual, the method comprising: administering to the individual, via at least one nasal cavity, a liquid or a fluid gel hypochlorous acid using a fine inhalable mist or a larger particle mist for the purpose of simply coating the inside of the nasal cavity, including the Nasal concha or Turbinate, internal naris and Nasopharynx.

In another embodiment, the invention provides a method of treating or preventing bacterial infection in an individual, the method comprising: administering to the individual's wound, ulcer, acne, tattoo, vagina, gums, or burn a quantity of liquid or fluid gel hypochlorous acid.

In still another embodiment, the invention provides a product comprising a chlorine/water mixture, in an alkaline state, stored in a barrier package for liquid or viscous products, as in a three-to-four-layer laminate bag of plastic and aluminum, or 2-3 layers of plastic, and a pH balancing acidic water liquid stored in its own barrier packaging technology for liquid or viscous products. In some embodiments, the chlorine/water mixture comprises NaClO and water. In some embodiments, the pH balancing acidic water includes sodium chloride. In some embodiments, the pH balancing acidic water further includes an inorganic, anti-settling surfactant.

Some embodiments of the invention provide for, but are not limited to, one or more of four basic formulas:
1. Chlorine/water (NaClO plus water), in an alkaline state, plus acidic water
2. Chlorine/water (NaClO plus water), in an alkaline state, plus acidic water, plus sodium chloride
3. Chlorine/water (NaClO plus water), in an alkaline state, plus, acidic water, plus, an inorganic, anti-settling, surfactant
4. Chlorine/water (NaClO plus water), in an alkaline state, plus acidic water, plus sodium chloride, plus an inorganic, anti-settling, surfactant

The illustrative aspects of the present inventive formulas are designed to solve the problems herein described and other problems not discussed which are discoverable by one skilled in the trade. As such, the invention provides for additional formulas to those detailed herein.

In some embodiments of the invention, the pH balancing acidic water is created by the mixture of deionized or distilled water and an acid comprising one or a combination of one or more acids selected from a group consisting of: HCl (hydrochloric acid), H₂SO₄ (sulfuric acid), HNO₃ (nitric acid), 2-Hydroxypropane-1,2,3-tricarboxylic acid (citric acid), C₃H₆O ₃(lactic acid), H₃NSO₃ (Sulfamic Acid), and C₅H₇NO₃ (pyroglutamic acid), resulting in a pH of 1-6. The pH of the acidic water required is based on the pH of the chlorine base liquid in order to achieve a final pH in a range of 3 to 7 and for a “Peak” HOCl in solution a range of 5-6.5 in the final mix to achieve a 100-90% HOCl efficiency.

The pH balancing acidic water may optionally include NaCl (sodium chloride) with a pH of 1-6. The pH of the acidic water, plus NaCl, required is based on the pH of the chlorine base liquid in order to achieve a final pH in a range of 3 to 7 and for a “Peak” HOCl in solution a range of 5-6.5 in the final mix to achieve a 100-90% HOCl efficiency.

In some embodiments, the chlorine/water (NaClO plus water), in an alkaline state, is created by the mixture of deionized or distilled water and a mixture of one or more, as an example, of lithium hypochlorite, calcium hypochlorite, or sodium hypochlorite; sodium chloride and/or chlorine gas, creating a pH of 9-13.

In some embodiments, the chlorine/water (NaClO plus water), in an alkaline state, has a strength of 500-5000 ppm (free-available chlorine) for the purpose of surface and atmospheric disinfection.

In some embodiments, the chlorine/water (NaClO plus water), in an alkaline state, has a strength of 50-500 ppm (free-available chlorine) for the purpose of wounds, ulcers acne, vaginal, gum diseases, tattoo, or burns disinfection. Preferably, the chlorine/water has a strength of 150-300 ppm (free-available chlorine).

In some embodiments, the chlorine/water (NaClO plus water), in an alkaline state, has a strength of 50-500 ppm (free-available chlorine) for the purpose of treating or preventing infection (such as a cold, flu or viruses) in an individual. Preferably, the chlorine/water has a strength of 150-300 ppm (free-available chlorine).

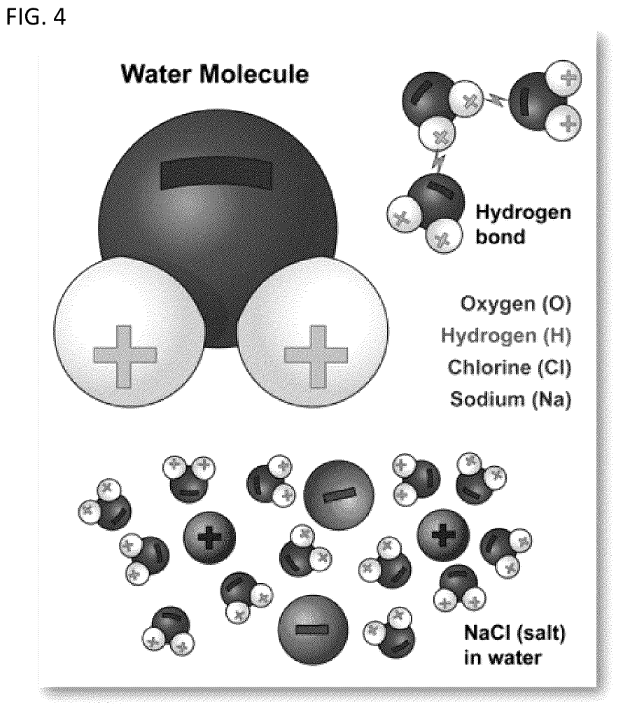

In some embodiments, the pH balancing occurs in the mixing valve and has a pH of 2-8, preferably a pH of 5-6.5. In such preferable embodiments, the HOCl is 90-100%, substantially that of human nasal and skin surfaces. In embodiments in which sodium chloride is included in the acid side of the packaging, the water molecules pull the sodium and chloride ions apart, breaking the ionic bond that holds them together. As a result, the sodium and chloride atoms are surrounded by water molecules, as shown in FIG. 4. in the result is a substantially homogeneous solution.

At the molecular level, salt dissolves in water due to electrical charges and due to the fact that both water and salt compounds are polar, with positive and negative charges on opposite sides of the molecules. The bonds in salt compounds are called ionic because they both have an electrical charge—the chloride ion is negatively charged and the sodium ion is positively charged. Likewise, a water molecule is ionic in nature, but the bond is called covalent, with two hydrogen atoms both situating themselves with their positive charge on one side of the oxygen atom, which has a negative charge. When salt is mixed with water, the salt dissolves because the covalent bonds of water are stronger than the ionic bonds in the salt molecules.

The positively-charged sides of the water molecules, containing the hydrogen atoms, are attracted to the negatively-charged chloride ions and the negatively-charged sides of the water molecules, containing an oxygen atom, are attracted to the positively-charged sodium ions. Essentially, a tug-of-war ensues pulls apart the salt molecules.

Salts, such as sodium chloride, are natural emulsifiers and therefore add to the ability of the liquid hypochlorous acid to coat or cling to a surface, increasing the surface tension of the disinfection area being treated. Improved contact results in improved disinfecting ability.

Preferred salts, free of all organic material, include Kosher Salt and Himalayan salt. Himalayan salt is packed with 84 minerals (plus Sulfur and sodium iodide) in traces that increase its healing and disinfection benefits. Himalayan salt also has an almost a two to one concentration of chloride to sodium content and the extra chloride increases free available ppm, which is depleted during the disinfection process.

When the Free Available Chlorine (in PPM) in the “Base” liquid (chlorine liquid) are mixed with Free Available Chlorine (in PPM) in the “Acidic liquid” (from the sodium chloride) the combination of the two parts becomes HOCl, Hypochlorous acid. When the Free Available Chlorine (PPM) are being used up in a Hypochlorous acid solution, during the disinfection process, the negatively-charged chloride ions, from the sodium chloride, attached by a “covalent” bond to the water hydrogen atoms, are released and become available to replenish the depleted chloride ions in the Hypochlorous acid solution. The chloride ions from the acidic side of the mix (created by the salt) are “ghost ions” and become part of the “fighting ions” when mixed. This action is due to the proper pH of the solution. At a pH of 5-6.5, the chloride ppm as used first as the solution is at a 100-90% efficiency.

In these reactions, the sodium ion is neither an acid nor a base (when mixed with water it becomes neutral, pH 7) The resulting mixed solution, with the extra sodium-ions, will not change the Hypochlorous acid composition's intended pH.

The illustrative aspects of the present invention are designed to solve the problems herein described and other problems not discussed which are discoverable by one skilled in the trade.

For example, a liquid or gelled HOCl composition such as those described above may be applied to a cloth or wipe for disinfecting. The foregoing description of various aspects of the invention has been presented for purposes of illustration and description. It is not intended to be exhaustive or to limit the invention to the precise forms disclosed and many modifications and variations are possible. Such modifications and variations that may be apparent to a person skilled in the art are intended to be included within the scope of the invention as defined by the accompanying claims.

What is claimed is:

1. A method of producing hypochlorous acid (HOCl), the method comprising:
mixing a first liquid comprising an alkaline chlorine-containing liquid and a second liquid comprising an acidic liquid to form a third liquid containing HOCl.

2. The method of claim 1, wherein the second liquid further comprises sodium chloride.

3. The method of claim 2, wherein the second liquid further comprises an inorganic surfactant.

4. The method of claim 1, wherein the second liquid further comprises an inorganic surfactant.

5. The method of claim 1, wherein the second liquid includes at least one acid selected from a group consisting of: hydrochloric acid, sulfuric acid, nitric acid, citric acid, lactic acid, sulfamic acid, and pyroglutamic acid.

6. The method of claim 5, wherein the second liquid has a pH of 1-6.

7. The method of claim 6, wherein the third liquid has a pH of 5-6.5.

8. The method of claim 1, wherein the first liquid includes at least one compound selected from a group consisting of: sodium hypochlorite, lithium hypochlorite, calcium hypochlorite, sodium chloride, and chlorine gas.

9. The method of claim 8, wherein the first liquid has a pH of 9-13.

10. The method of claim 8, wherein the third liquid has a pH of 5-6.5.

11. An apparatus for producing hypochlorous acid (HOCl), the apparatus comprising:
a first container containing a first liquid comprising an alkaline chlorine-containing liquid;
a second container containing a second liquid comprising an acidic liquid; and
an actuator fluidly connected to the first and second containers, operable to mix the first and second liquids and dispense a third liquid comprising the mixed first and second liquids.

12. The apparatus of claim 11, wherein the second liquid further comprises sodium chloride.

13. The apparatus of claim 12, wherein the second liquid further comprises an inorganic surfactant.

14. The apparatus of claim 11, wherein the second liquid further comprises an inorganic surfactant.

15. The apparatus of claim 11, wherein the second liquid includes at least one acid selected from a group consisting of: hydrochloric acid, sulfuric acid, nitric acid, citric acid, lactic acid, sulfamic acid, and pyroglutamic acid.

16. The apparatus of claim 15, wherein the second liquid has a pH of 1-6.

17. The apparatus of claim 16, wherein the third liquid has a pH of 5-6.5.

18. The apparatus of claim 11, wherein the first liquid includes at least one compound selected from a group consisting of: sodium hypochlorite, lithium hypochlorite, calcium hypochlorite, sodium chloride, and chlorine gas.

19. The apparatus of claim 18, wherein the first liquid has a pH of 9-13.

20. The apparatus of claim 18, wherein the third liquid has a pH of 5-6.5.

21. The apparatus of claim 11, further comrising:
a third container within which the first and second containers are disposed and to which the actuator is attached.

22. The apparatus of claim 21, wherein the third container is internally pressurized.
